(19) United States
(12) Patent Application Publication
(10) Pub. No.: US 2022/0327006 A1
(43) Pub. Date: Oct. 13, 2022

(54) PROCESS ORCHESTRATION IN ENTERPRISE APPLICATION OF CODELESS PLATFORM

(71) Applicant: NB Ventures, Inc. dba GEP, Clark, NJ (US)

(72) Inventors: Subhash Makhija, Westfield, NJ (US); Huzaifa Shabbir Matawala, East Brunswick, NJ (US); Saratendu Sethi, Apex, NC (US); Shivendra Singh Malik, Vasco-da-Gama (IN)

(21) Appl. No.: 17/227,176

(22) Filed: Apr. 9, 2021

(51) Int. Cl. G06F 9/50; G06N 20/00; G06F 9/451; H04L 29/06

(52) U.S. Cl. CPC G06F 9/5088; G06N 20/00; G06F 9/505; G06F 9/451; H04L 67/40

(57) ABSTRACT

The present invention provides a system and a method of Process Orchestration in supply chain management enterprise application developed on codeless Platform architecture. The Process Orchestration includes an API for configuration, AI based Orchestration engine for interaction with one or more configurable components, an Orchestrator UI for monitoring and providing visibility across workflow and an Orchestrator manager for controlling the structure of the workflow.

### BACKGROUND

### 1. Technical Field

The present invention relates generally to enterprise applications. More particularly, the invention relates to process orchestration in Supply chain management (SCM) enterprise application of codeless platform architecture.

### 2. Description of the Prior Art

In any organization to meet the operational requirements, an enterprise application of the organization requires certain customization capabilities. However, it is impractical for a service provider to restructure the enterprise application every time a new entity raises a distinct operational requirement.

Every end user of an enterprise application has a different operational requirement depending on industry verticals and variations based on region of operation. It is impractical to accommodate to such requirements through the existing enterprise applications.

Further, there are unique challenges with applications developed on codeless platform due to the inherent nature of the development framework. The architecture remains unsupportive in multiple aspects including dynamic workflows. Even with codeless development integration of multiple functions while dealing with distinct data without impacting functionality of the applications is cumbersome to design. The basic structure of applications supporting such development have inherent issues due to the complexity of the functions to be executed in supply chain management applications. None of the prior arts address the structural complexity and technical issues in executing complex functions through an enterprise application that are supported by existing architecture designs and infrastructure.

Further, the platforms have limited capability and applications developed through the platform are relevant to industry domains, where work moves from one desk to another or one mailbox to another. Any development in undertaken from scratch which makes it tedious and time consuming. Moreover, Orchestration of systems, process, applications and associated services through the codeless platforms are extremely complex.

In view of the above problems, there is a need for a system and method of orchestration in enterprise application developed on codeless platform that can overcome the problems associated with the prior arts.

### SUMMARY

According to an embodiment, the present invention a System for process Orchestration in Supply chain management application. The system includes an application programming interface (API) for providing access to configuration and workflow operations of the one or more SCM application, an AI based orchestration engine configured for interacting with one or more configurable components in a codeless platform architecture for executing one or more SCM operations wherein the AI based orchestration engine drives execution of the SCM operations through one or more data objects mapped to the API for structuring at least one workflow of the SCM operation by a process modeler of the AI based orchestration engine, an orchestrator UI for monitoring and providing visibility for structuring the at least one workflow wherein the orchestrator UI monitors the at least one structured workflow and a task executed through the structured workflow of the SCM operations; and an orchestrator manager configured to control the structuring of the at least one workflow wherein the orchestrator manager controls the at least one structured workflow and the task executed through the structured workflow of the SCM operations.

In an embodiment, the present invention provides a method of Process orchestration in supply chain management (SCM) application. The method includes the steps of receiving a request at a server to structure at least one workflow of one or more SCM operations, providing by an API, access to configuration and workflow operations of one or more SCM application, interacting by an AI based orchestration engine with one or more configurable components in a codeless platform architecture for executing the SCM operations wherein the AI based orchestration engine drives execution of SCM operations through one or more data objects mapped to the API for structuring the at least one workflow of the SCM operations by a process modeler of the AI based orchestration engine, monitoring and providing visibility for structuring the at least one workflow by an orchestrator UI wherein the orchestrator UI is configured to monitor the at least one structured workflow and a task executed through the structured workflow of the SCM operations; and controlling the structuring of the at least one workflow by an Orchestrator manager wherein the Orchestrator manager is configured to control the at least one structured workflow and the task executed through the structured workflow of the SCM operations.

In an embodiment, the method of the invention further includes remodeling a structure of the at least one workflow based on transactions performed through the workflow and corrected outliers.

In an embodiment, the present invention provides a computer program product for process orchestration in SCM enterprise applications of a computing device with memory. The product includes a computer readable storage medium readable by a processor and storing instructions for execution by the processor for performing the above method.

In an advantageous aspect, the system and method of the invention structures a workflow dynamically with model driven AI (artificial intelligence). Further, the present invention utilizes Machine Learning algorithms, prediction data models, artificial intelligence-based process orchestration for execution of one or more SCM application operations.

### BRIEF DESCRIPTION OF THE DRAWINGS

The disclosure will be better understood and when consideration is given to the drawings and the detailed description which follows. Such description makes reference to the annexed drawings wherein:

FIG. 1 is a system diagram for codeless development of one of more SCM enterprise applications in accordance with an example embodiment of the invention.

FIG. 1A is a process orchestrator schematic diagram in accordance with an embodiment of the invention.

FIG. 1B is a visualization workflow in accordance with an embodiment of the invention.

FIG. 1C is a workflow engine schematic diagram in accordance with an embodiment of the invention.

FIG. 2 is a block diagram depicting AI Orchestration Overlay of Process Orchestrator in accordance with an embodiment of the invention.

FIG. 2A is a flow diagram depicting a predicted flow of operations task by AI flow Orchestrator engine in accordance with an embodiment of the invention.

FIG. 2B is a flow diagram depicting clustering for determining operational rules by AI flow Orchestrator engine in accordance with an embodiment of the invention.

FIG. 2C is a flow diagram depicting process mining by AI task Orchestrator engine in accordance with an embodiment of the invention.

FIG. 2D is a flow diagram depicting user approval and automated approval of process flows by AI task Orchestrator in accordance with an embodiment of the invention.

FIG. 2E is a flow diagram depicting anomaly detection flow by AI Compliance Orchestrator engine in accordance with an embodiment of the invention.

FIG. 2F is a flow diagram depicting approval level optimization by AI Compliance Orchestrator engine in accordance with an embodiment of the invention.

FIG. 3 is task and action service block diagram as part of process orchestration in accordance with an embodiment of the invention.

FIG. 3A is a flow diagram depicting event handler configuration as part of Process Orchestration in accordance with an embodiment of the invention.

FIG. 3B is flow diagram depicting data events handler as part of Process Orchestration in accordance with an embodiment of the invention.

FIG. 4 is a flowchart depicting a method of process Orchestration in SCM enterprise application in accordance with an embodiment of the invention.

FIG. 5 is a flow diagram depicting creation of invoice workflow as a supply chain operation in accordance with an embodiment of the invention.

FIG. 5A is a flow diagram depicting copy invoice workflow as a supply chain operation in accordance with an embodiment of the invention.

FIG. 5B is a flow diagram depicting cancel invoice workflow as a supply chain operation in accordance with an embodiment of the invention.

FIG. 5C is a flow diagram depicting creation of invoice from Purchase Order workflow as a supply chain operation in accordance with an embodiment of the invention.

FIG. 5D is a flow diagram depicting submission of Invoice workflow as a supply chain operation in accordance with an embodiment of the invention.

FIG. 5E is a flow diagram depicting creation of sales invoice workflow as a supply chain operation in accordance with an embodiment of the invention.

FIG. 5F is a flow diagram depicting push invoice workflow as a supply chain operation in accordance with an embodiment of the invention.

FIG. 5G is a flow diagram depicting rejecting invoice workflow as a supply chain operation in accordance with an embodiment of the invention.

FIG. 6 is a flow diagram of create contract object flow operation of a contract lifecycle management application in accordance with an embodiment of the invention.

### DETAILED DESCRIPTION

Described herein are the various embodiments of the present invention, which includes process orchestration in enterprise application developed with codeless platform architecture.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “task,” “compliance,” or “resource”,” and the like, may be used herein for ease of description to describe one element or feature's relationship to another element(s) or feature(s) as illustrated in the figures. It will be understood that the spatially relative terms are intended to encompass different workflows of the process in use or operation in addition to the workflows depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to process orchestration in enterprise application including supply chain management application developed with codeless platform architecture.

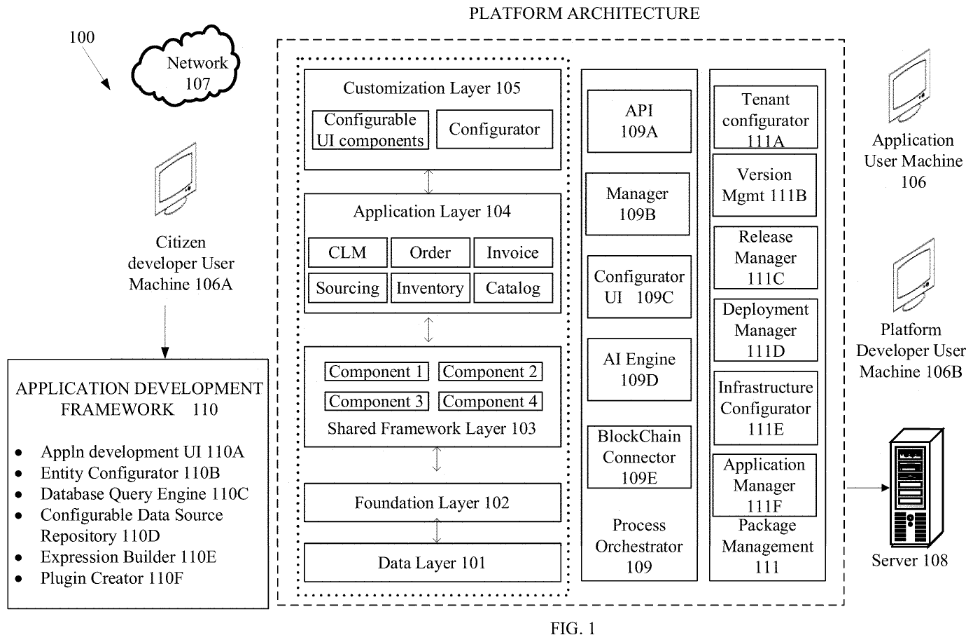

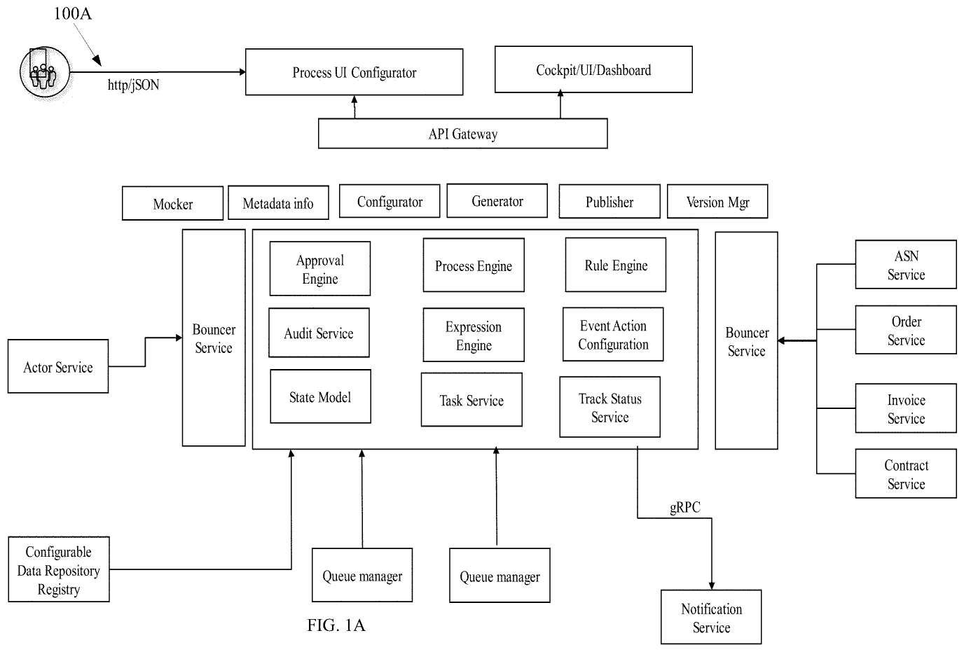

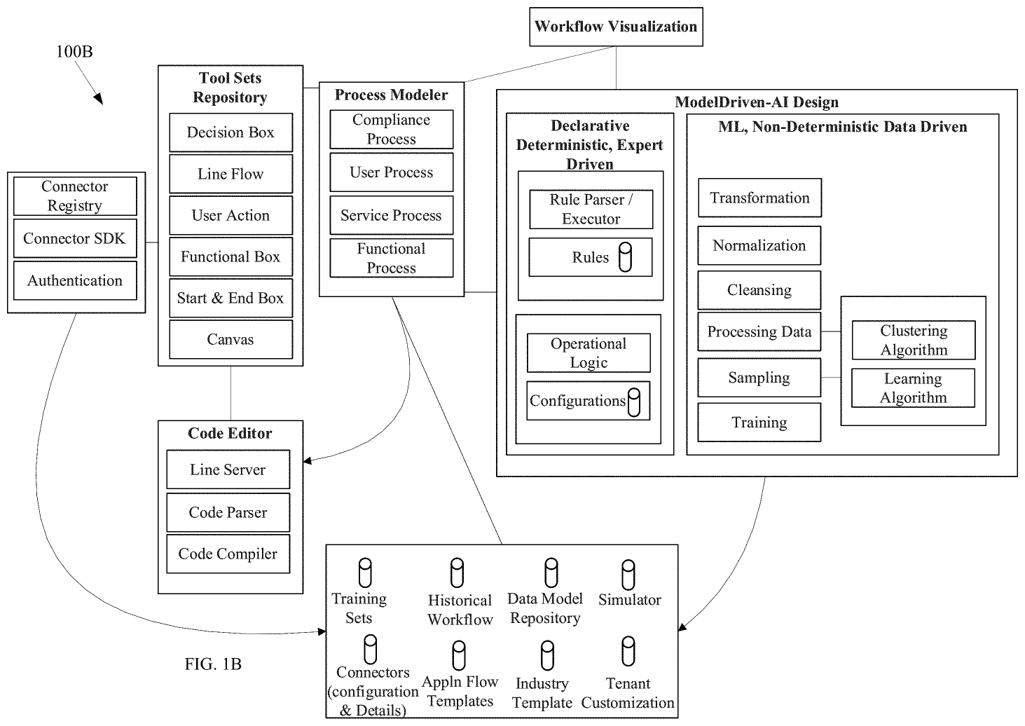

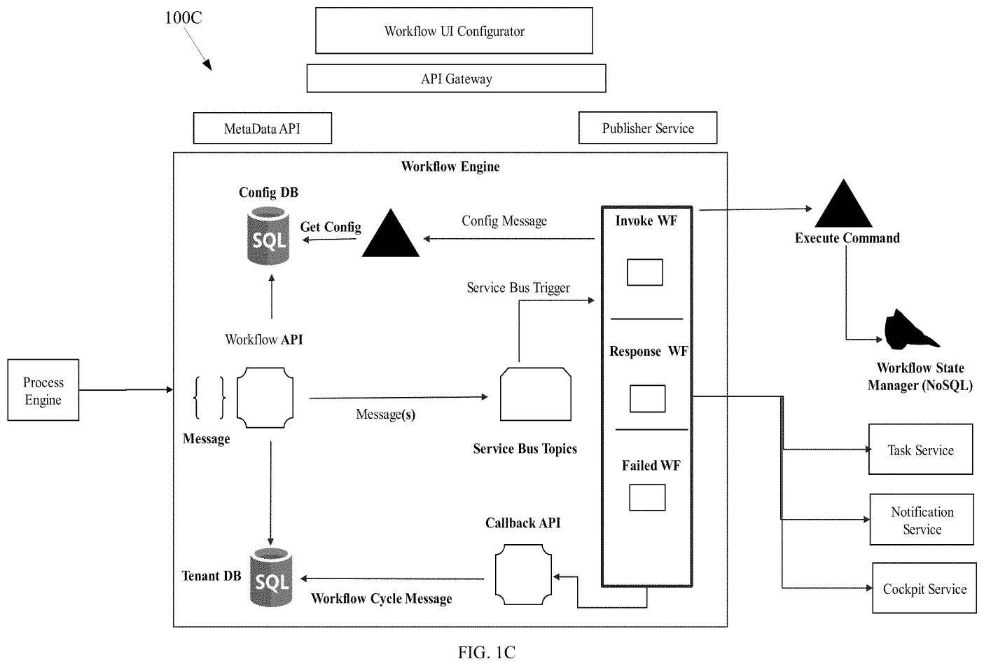

Referring to FIG. 1, a system diagram 100 for codeless development of one or more SCM enterprise application with process orchestration is provided in accordance with an embodiment of the present invention. The system 100 is configured to process complex operations of one or more SCM applications using configurable components of each layer of a codeless platform architecture. The layered architecture enables faster processing of complex operations as the workflow may be reorganized dynamically using the configurable components. The layered architecture includes a data layer 101, a foundation layer 102, a shared framework layer 103, an application layer 104 and a customization layer 105. Each layer of the architecture includes a plurality of configurable components interacting with each other to execute at least one operation of the SCM enterprise application. It shall be apparent to a person skilled in the art that while FIG. 1 provide some components of the system, the nature of the components itself enables redesigning of the platform architecture through addition, deletion, modification of the configurable components and their positioning in the layered architecture. Such addition, modification of the components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine 106A, and a platform developer user through its computing device 106B triggers the shared framework layer 103, the foundation layer 102 and the data layer 101 to structure the platform for enabling codeless development of SCM applications.

In an embodiment the present invention provides one or more SCM enterprise application with an end user application UI and a citizen developer user application UI for structuring the interface to carry out the required operations.

In one embodiment, the architecture provides the cloud agnostic data layer 101 as a bottom layer of the architecture. This layer provides a set of micro-services that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP-online transactional processing).

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

The memory data store/data lake of the data layer/storage platform layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

In an embodiment the system of the present invention built on the codeless platform architecture where the architecture provides the foundation layer 102 on top of the data layer 101 of the architecture. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permissioning) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

In a related embodiment, the plurality of configurable components includes one or more shared framework configurable components including but not limited to license manager, Esign service, application market place service, Item Master Data Component, organization and accounting structure data component, master data, Import and Export component, Tree Component, Rule Engine, Workflow Engine, Expression Engine, Notification, Scheduler, Event Manager, and version service.

In a related embodiment, the configurable component scheduler manages jobs and scheduler expressions for any applications to trigger API. It is used to schedule reminder notifications, backend jobs etc.

In one embodiment, the architecture provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of orchestrations of all these functionalities is possible to build by custom implementations for end users. The platform will stay pristine and clean and be generic, while at the same time, enables truly custom features to be built in a lightweight and agile manner.

In a related embodiment, the plurality of configurable components includes one or more application layer configurable components including but not limited to domain Gateway Service, Stakeholder Component, application header service, application Line items component, Milestones component, key performance indicator (KPI) component, section component, section component, and metadata component for developing and managing at least one application service.

In an embodiment, the codeless platform architecture provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute one or more SCM operation.

In an exemplary embodiment, each of these layers of the platform architecture communicates or interacts only to the layer directly below and never bypasses the layers through operational workflow thereby enabling highly productive execution with secured interaction through the architecture.

Further, depending on the type of user, the user interface (UI) of the entity machines (106, 106A, 106B) is structured by the platform architecture. The entity machine 106A with a citizen developer user UI is configured for sending, receiving, modifying or triggering processes and data object for creation of one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the entity machines (106, 106A, 106B). The system 100 includes a support mechanism for performing various prediction through AI engine and mitigation processes with multiple functions including historical dataset extraction, classification of historical datasets, artificial intelligence based processing of new datasets and structuring of data attributes for analysis of data, creation of one or more data models configured to process different parameters, structuring of workflows etc.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by processor. The electronic circuitry has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low speed interface connecting to low speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

The processor may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In an example embodiment, the system of the present invention includes a front-end web server communicatively coupled to at least one database server, where the front-end web server is configured to process the dataset characteristic data based on one or more prediction data models and applying an AI based dynamic processing logic to automate codeless development actions through process orchestrator for structuring the workflow.

In an embodiment, the system 100 of the invention includes the process orchestrator 109 configured for enabling interaction of the plurality of configurable components in the layered architecture for executing one or more SCM operation and development of the one or more SCM application. The process orchestrator 109 includes an application programming interface (API) 109A for providing access to configuration and workflow operations of SCM application operations, an Orchestrator manager 109B configured for Orchestration, controlling the structure and task executed through the workflow of the SCM application operations, an orchestrator UI/cockpit 109C for monitoring and providing visibility across structured workflows and the task executed through the workflow of the SCM operations and an AI based process orchestration engine 109D configured for interacting with a plurality of configurable components in the platform architecture for executing SCM operations, where the AI based orchestration engine 109D drives execution of SCM operations through one or more data objects mapped to the API for structuring the workflow of the SCM operation by a process modeler of the AI based orchestrator engine 109D.

In one embodiment, the one or more data objects includes event data object, state data object, action data object and access control data objects, stakeholder types, rule expression data object, master data objects. The event data objects, and action data objects are mapped to endpoints of the API. Also, the event data objects are connected to action data objects and action data objects are associated to state data objects.

In another embodiment, the one or more data objects includes application functional data objects such as Taxonomy associated to a document, sub class of the document (contract type, PO type, Invoice type, business unit, line of business, ship and bill to location, item category, stakeholder types) document Types, Application Types, Supplier location, Region of business, taxation attributes, Line attributes, clause type, approval type, and document value (invoice amount, contract amount).

It shall be apparent to a person skilled in the art, that the data objects listed in the application are examples relating to data objects for Process Orchestration in Supply chain application. The list provided is not exhaustive and may include other data objects that are withing the scope of the current disclosure related to supply chain application.

In an embodiment, the system 100 of the present invention provides a historical workflow knowledge database configured for storing historical workflow dataset wherein the workflow of the SCM operation is structured based on the historical workflow dataset by building model-driven flows incorporating application process within supply chain.

In an embodiment, the process orchestrator 109 includes a blockchain connector 109E for integrating blockchain services with the one or more SCM application and interaction with one or more configurable components. Further, Configurator User interface (UI) services are used to include third party networks managed by domain providers.

In a related aspect, the orchestrator UI 109C provides details through graphical representation to customize data flow, workflow, manage run, settings and configuration to execute the workflow. The AI based orchestrator engine 109D coupled to a processor execute SCM operation by at least one data model wherein the AI engine transfers processed data to the UI for visibility, exposes SCM operations through API and assist the manager for orchestration and control. FIG. 1A, shows a process orchestrator schematic block diagram 100A.

In an embodiment, the present invention uses GPUs (Graphical processing units) for enabling AI engine to provide computing power to processes humongous amount of data.

In an exemplary embodiment, the AI engine employs machine learning techniques that learn patterns and generate insights from the data for enabling the process orchestrator to automate operations. Further, the AI engine with ML employs deep learning that utilizes artificial neural networks to mimic neural network. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for development of the SCM enterprise application.

Referring to FIG. 1B, a workflow visualization schematic block diagram 100B in accordance with an embodiment of the invention. The workflow visualization includes process orchestration generator through Model driven AI pattern. It is responsible to generate operational process workflow like business process through AI using model driven pattern. The models are generated using combination of historical workflow and details from experts. Modeling decision of existing business process are driven manually by Subject Matter Expert. Combining Functional Industry Knowledge and its structure into rules. Decision are better approached by using Industry Knowledge and Machine Learning (making use of Historical knowledge Data). The ML makes predictions based on the historical workflow data as predictions brings knowledge of operational/business process and interpretation and the predictions are non-deterministic.

Further, data driven model relies on larger volume of data. The data driven AI pattern is driven by historical knowledge data while deterministic are driven through expert and deep learner's engine focused on specific problem areas. The data driven AI patterns relies on smaller data sets which are accurate as they are focused on procurement and supply chain workflows and targeted for various industry verticals. The combination of subject matter expert small data for AI and big data for AI accelerates the model-driven AI workflow pattern. In the present invention a combination of subject matter expert and machine-driven training is applied simultaneously to feed small data expertise into machines. The intelligent model driven AI with Orchestration engine leverages small data to enhance operational process.

In a related embodiment, the model-driven AI flow with the cordless platform architecture enables users to access data in a unified manner regardless of the underlying data store. Data store queries (e.g., relational, or file systems) are significantly streamlined for structuring the workflow. The essential aspects of time and space, data normalizing, versioning, and tracking are all handled by the Process Orchestration system thereby enabling the developer to work on functional performance.

The workflow visualization includes processing of functional industry knowledge with declarative and deterministic AI which deals with controlled section of operational/business logic provided by industry experts. Further, the workflow includes interpretation of regulations and policies to be applied to business processes.

In another related embodiment, the workflow visualization block 100B includes a process modeler that is responsible to generate notations and defines process as per trained models saved in the repository. The process modeler manages various processes, responsible to integrate these processes and use tools repository to structure the workflow. Further, the workflow includes compliance process with validation of end to end flows and is responsible to verify and simulate the flow as per the data model. The compliance process identifies outliers and generates alerts along with replaying the events. Furthermore, the workflow block 100B includes a user process block that generates notations, identifies blocks requiring user intervention, defines start and end of the flow, and connects user action to business events.

In another embodiment, the workflow visualization block 100B includes service process that generates definition of microservice blocks, runs in-memory in the engine and have a single responsibility. The service processes include sub processes and is high performant. Further, the workflow block 100B includes functional process as a critical block with ability to connect with code server for custom implementation. It invokes API. Further decision process includes decision blocks that are generated through a rule engine.

Referring to FIG. 1C, a workflow engine schematic block diagram 100C in accordance with an embodiment of the invention. The workflow engine enables monitoring of workflow across the SCM applications. The workflow engine with the Process orchestrator enables the platform architecture to create multiple approval workflows.

In an embodiment the entity machines (106, 106A, 106B) may communicate with the server 108 wirelessly through communication interface, which may include digital signal processing circuitry (FIG. 1). Also, the entity machines (106, 106A, 106B) may be implemented in a number of different forms, for example, as a smartphone, computer, personal digital assistant, or other similar devices.

In an exemplary embodiment, the developer application user interface (UI) and the application user interface of the entity machines (106, 106A) enables cognitive computing to improve interaction between user and an enterprise or supply chain application(s). The interface improves the ability of a user to use the computer machine itself. Since, the interface triggers configurable components of the platform architecture for structuring an SCM application with workflow to execute at least one operation including but not limited to creation of Purchase order, Contract lifecycle management operations, Warehouse management operations, inventory management operations etc., at the same instant, the interface thereby enables a user to take informed decision or undertake an appropriate strategy for adjusting workflow for execution of operations. By structuring operations and application functions through a layered platform architecture and eliminating multiple cross function layers, repetitive processing tasks and recordation of information to get a desired data or operational functionality, which would be slow and complex the user interface is more user friendly and improves the functioning of the existing computer systems.

In an embodiment the system 100 of the present invention provides a development application framework 110 for codeless development of SCM applications (FIG. 1). The framework 110 includes an application user interface (UI) 110A of a development application having a plurality of data objects configured to trigger a plurality of configurable component of a layered platform architecture to structure one or more SCM application. The framework 110 also includes an entity configurator 110B for defining a plurality of configuration parameters to create the SCM application, a database query engine 110C configured to fetch data from a plurality of distinct databases, a configurable data source (CDS) repository 110D for storing a plurality of API configured to be invoked dynamically by a user through the interface for creating the SCM application, an expression builder 110E configured for customizing application processing logic for execution of one or more SCM operation, and a plugin creator engine 110F configured to implement a plurality of reusable plugin for enriching the layered platform architecture. Some of the features for CDS includes Enhancing CDS user experience for developers, support multiple API calls, identify dependencies in real time, dynamically configure API using NoSQL database, Header level UX enhancements for CDS, and access control. The configurable data sources include mergeable endpoints, parameterized endpoints, endpoint dependencies and a data model massager. The data source such as inventory, purchase order, invoices, finance modules, contracts, RFx modules, supplier module, item master, supplier master, bill of materials, vendor master, warehouse management module and logistics management module are configurable for restructuring the application. The application user interface 110A includes a UI form builder component to structure one or more SCM application for executing one or more SCM operation by a SCM application end user through a SCM application UI. The plurality of API is configured to interact with the application framework wherein an AI based processing logic integrates deep learning, predictive analysis, information extraction and robotics for triggering a dynamic data object injector to conditionally load the plurality of data objects on the SCM application UI thereby processing the one or more SCM application operation.

In a related embodiment, the system 100 provides package management 111 (FIG. 1). Component plays a larger role to manage and deploy package through automation process, using various sub-components such as Tenant Configurator 111A, version management 111B, Release manager 111C, Deployment Manager 111D, Infrastructure configurator 111E and application manager 111F. These components provide window for platform developer, application developer to release the packages and provide visibility of the deployment pipeline. The tenant configurator 111A enables deployment of packages to one or more clients across environments. It provides ability to create and manage details of customers through UI. It gives deployment experience through projects and environments to support the tenant concept. The Version management component 111B manages multiple versions of the packages and changes made by application developers and platform developers. The component provides UI to look at multiple versions of the package and compare versions. It manages minor and major versions. The release manager component 111C is responsible for managing, planning, scheduling, and controlling delivery throughout the release lifecycle using other subcomponents and for Orchestrating entire pipeline with automation. The deployment manager component 111D configures and run delivery workflows for applications and platforms. It Creates standardized deployment process to deploy predictable, high-quality releases. The component automates workflows, including versioning, application package generation, artifact management, and package promotion to different stages in the workflow. The infrastructure configurator component 111E is responsible to provision services and database repositories as per application and loads. The component supports automation to provision infrastructure as per release and version. The application manager component 111F enables structuring of multiple versions of applications developed by application developer on the screen and allows tenant and customers to select the version.

In an exemplary embodiment, apart from application user interface, output of the layered platform architecture is exposed as API for third party digital platforms and applications. The API is also consumed by bots and mobile applications.

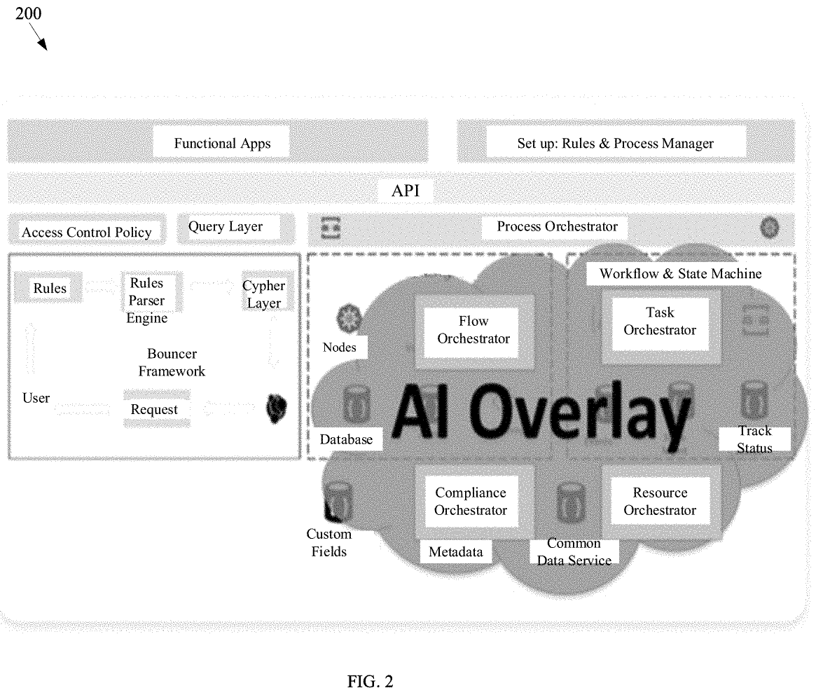

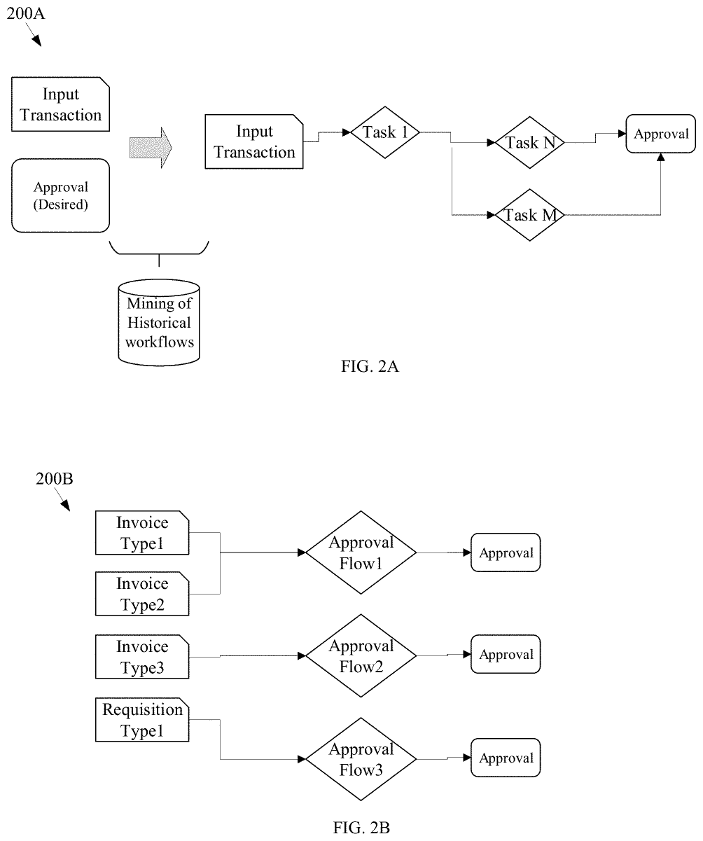

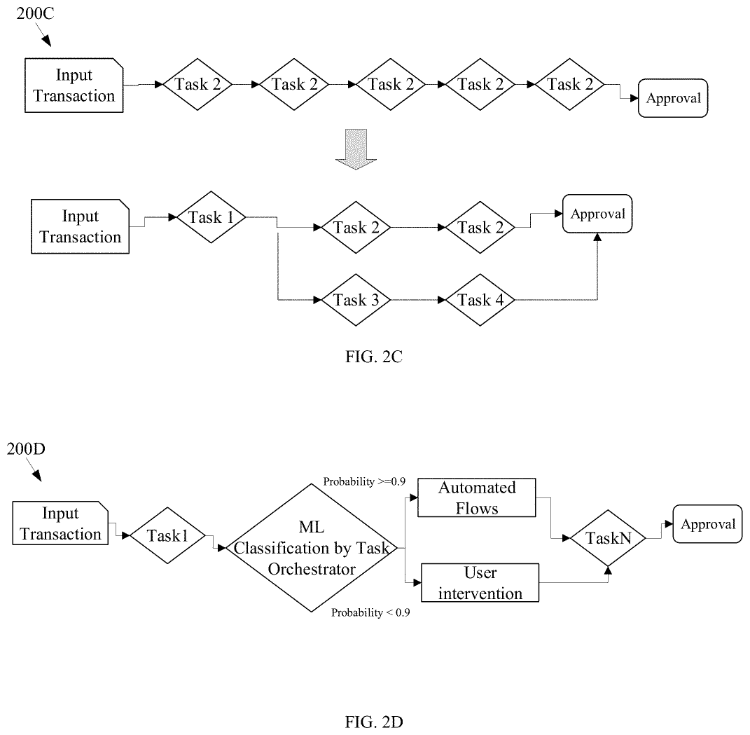

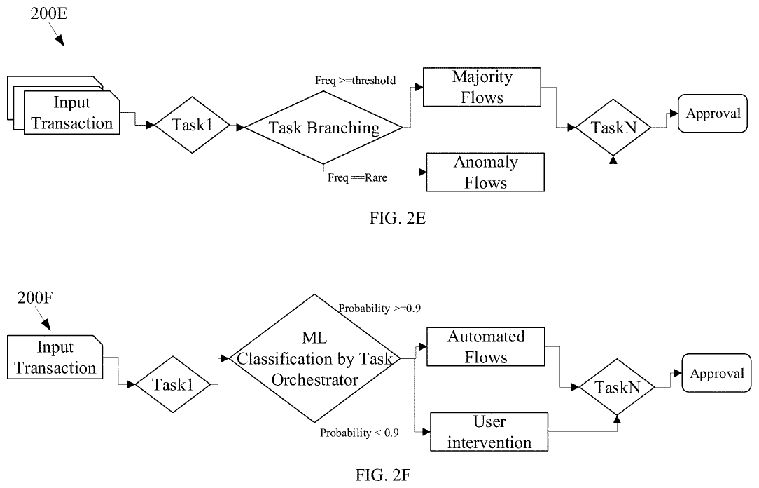

Referring to FIG. 2 a block diagram of the system 200 with AI Orchestration Overlay is provided in accordance with an embodiment of the invention. The system manages life cycle of the document, invokes rule engine and State Machine based on configuration and settings for the user. The messages are routed through a broker queue and communication with user is through async protocol. The AI based Orchestration engine helps drive process automation across multi-functional documents/applications. The process Orchestrator is responsible to interact with several other components. Orchestrator is also responsible to communicate with external systems (process components). Some of the features are UI layer to define stages using operational (Business process BPM) standards, State Machine & Action; integration with Rule Engine; Ability to create different types of approval workflow; Track Status; Workflow monitoring; Cockpit View; Action Panel; Access Control through Data Network.

In an embodiment, the process orchestrator is overlaid with AI fabric layer that continually mines various aspects of processes. It comprises of multiple AI engines that perform different analyses including AI flow orchestrator engine 201, AI task orchestrator engine 202, AI Compliance Orchestrator engine 203 and AI resource Orchestrator engine 204.

In an embodiment, the AI Flow orchestrator engine 201 includes AI algorithms that monitor and learn the flow of input transactions data across different stages to reach final approvals. The AI Task orchestrator engine 202 includes AI algorithms that determine the relative importance of different business rules/tasks to either automate repetitive/redundant tasks or determine dependencies to introduce execution optimizations. The AI Compliance orchestrator engine 203 includes AI algorithms that determine anomalies or process pattern drifts to alert administrators. The AI Resource orchestrator engine 204 includes AI algorithms that focus on “importance-driven” QoS (Quality of Service) requirements to optimize resource allocation of the platform.

In an embodiment, the AI flow Orchestrator engine 201 takes a record centric view of all transactions applied to different records for the approval process. For example, an invoice record goes through different verification stages compared to a requisition for approval. Even within those types, there may be subtypes which require different business rules to act on them. The AI actions of Flow Orchestrations is explained in flow diagrams 200A and 200B of FIGS. 2A and 2B. In FIG. 2A, given an input transaction record and the desired approval, the user is guided with a predicted flow of operational/business tasks that would take the transaction to the intended output. In flow diagram 200B of FIG. 2B, performing clustering of transactions based on various attributes and operational/business metadata to determine the appropriate operational rules flow.

In an exemplary embodiment, the implementation for the flow diagrams in 2A and 2B includes step of performing clustering on input transactions to group similar incoming transaction types. Further, within a cluster, for each input transaction extracting following details from ACT_HI_ACTINST:

(1) ROOT_PROC_INST_ID: The process identifiers related to this set of transactions.
(2) Extracting the task sequences by traversing through (PROC_INST_ID, ACT_ID, TASK_ID).
The implementation further includes performing a sequential pattern mining to determine the common sequence of executed tasks on this cluster of input transactions which can be recommended to the user.

In an embodiment, the AI task Orchestrator engine 202 takes a task-centric view and monitors the relative importance of operational/business rules that act upon an input transaction. The primary responsibility of this engine 202 is to determine whether a rule is effective for an input transaction or is it just a pass-through which can help in deciding on the weightage of that rule and whether expert intervention is required (if the rule needs separate approval). The engine 202 performs process mining to determine the process reality vs. process flow as shown in flow diagram 200C of FIG. 2C.

In an exemplary embodiment, the implementation for the flow diagrams in 2C includes step of extracting following details for a set of input transactions from ACT_HI_ACTINST:

(1) ROOT_PROC_INST_ID: The process ids related to this set of transactions
(2) Extracting the tasks TASK_ID that operate on this transaction
The implementation further includes building a conditional probability matrix to predict the importance of task to task dependency and task to approval dependence. The system uses Bayesian inferencing to identify the key tasks that would lead to approval.

The AI task orchestrator engine 202 further determine tradeoff between tasks that require user approval vs. automated approval to enable automation of process flows as shown by flow diagram 200D of FIG. 2D. The implementation of the flow diagram 200 D includes augmenting the Bayesian model obtained in previous step with additional metadata from the transaction, using the posterior probabilities of each task against the approval of the transactions to determine the importance likelihood of the specific task and for tasks with high importance (e.g. posterior probability >=0.9) and attribute==Automated, the system can automate the approval. Further the attributes can be configured for each task.

In an embodiment, while the Flow and Process Orchestrator components of AI Overlay focus on the mining of physical transactions and the business tasks, the compliance orchestrator 203 in turn mines on the overall flows and processes that are managed by the process orchestrator. To that end, AI will perform following activities:

### (1) Anomaly Detection

The module will identify one-off flows or issues/blockages that may arise with automation of various steps, viz. failure modes. In large organizations, this module will also be helpful to identify situations of fraud as shown in flow diagram 200E of FIG. 2E. The implementation of the anomaly detection includes performing clustering on input transactions to group similar incoming transaction types, extracting for each input transaction the following details from ACT_HI_ACTINST:
(i) ROOT_PROC_INST_ID: The process ids related to this set of transactions
(ii) Extract the task sequences by traversing through (PROC_INST_ID, ACT_ID, TASK_ID)
Train different ML algorithms on false positives (e.g., Random Forest, neural networks/deep learning, Isolation forests);
else, using outlier detection algorithms, like principal component analysis and distributed stochastic neighbor embedding.

### (2) Approval Level Optimization

Depending on the criticality of required approvals, the ML classification model described in “AI Task orchestrator” section can also be extended to classify the level of User intervention. For example, the ML classification model can leverage the organizational hierarchy to route high-value invoices to managers for approvals and simple invoices get auto-approved but general invoices requiring attention get routed to financial analysts as depicted by flow diagram 200F in FIG. 2F. The implementation of the Optimization includes extension of Machine learning classification model described above in AI task Orchestrator.

### (3) Determine Drifts in Workflows and Evolving Workflows

Determine changing and evolving workflow changes and classify them as: (i) abrupt; (ii) gradual; and (iii) trended/seasonal. This module looks at a workflow sequence over time, tracks sequence changes to the workflow over time and computes distance between the workflow sequences to determine drifts and evolutions. It also performs clustering of task sequences over time to determine any seasonality patterns. The implementation includes extracting all task sequences from ACT_HI_ACTINST and ACT_HI_TASKINST and Using process mining for drift detection.

### (4) Perform Community Intelligence Across all Customers to Suggest Gaps

This module looks at all the task sequences and uses suffix tree algorithms for large scale sequence alignment and comparison. For each task sequence, the nearest sequences can be provided as recommendations. ACT_HI_TASKINST will have all the data required for this step.

In an embodiment the AI resource Orchestrator 204 adds a resource angle (viz. timing, hardware resources, cost impact) to optimize. At this point only the execution times are recorded for each task. So, the system can predict things like remaining time. The ACT_HI_ACTINST has start time and end time values.

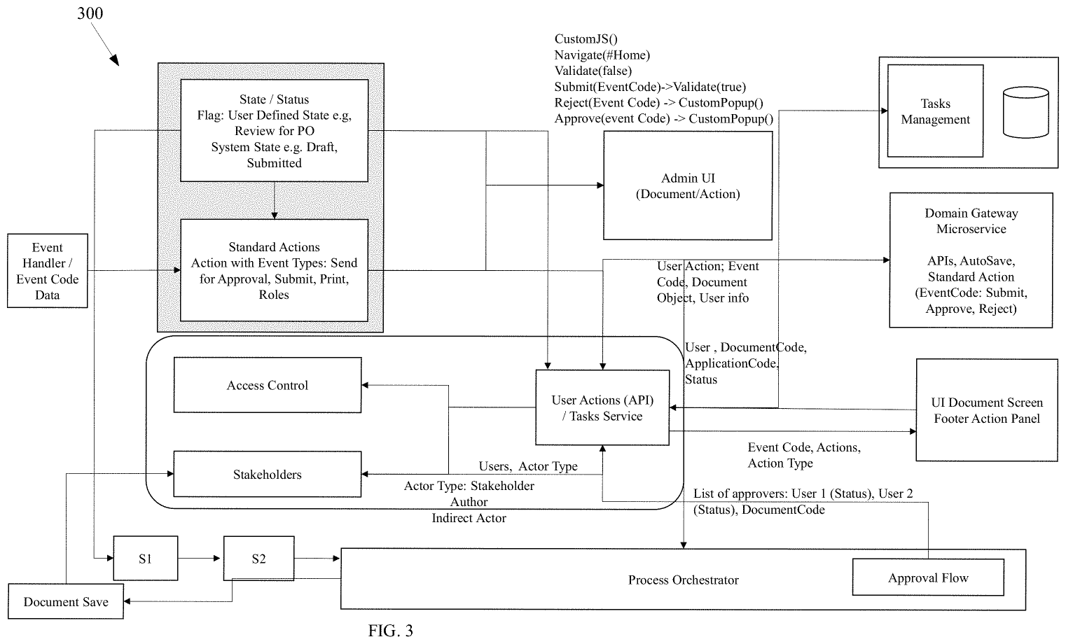

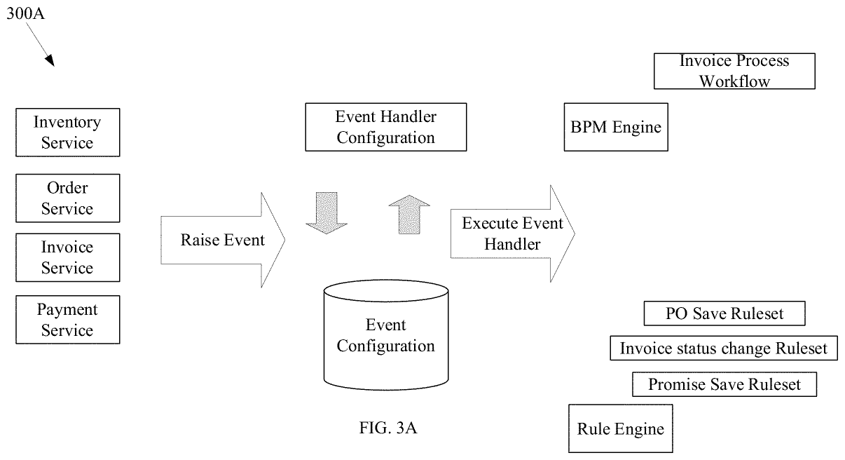

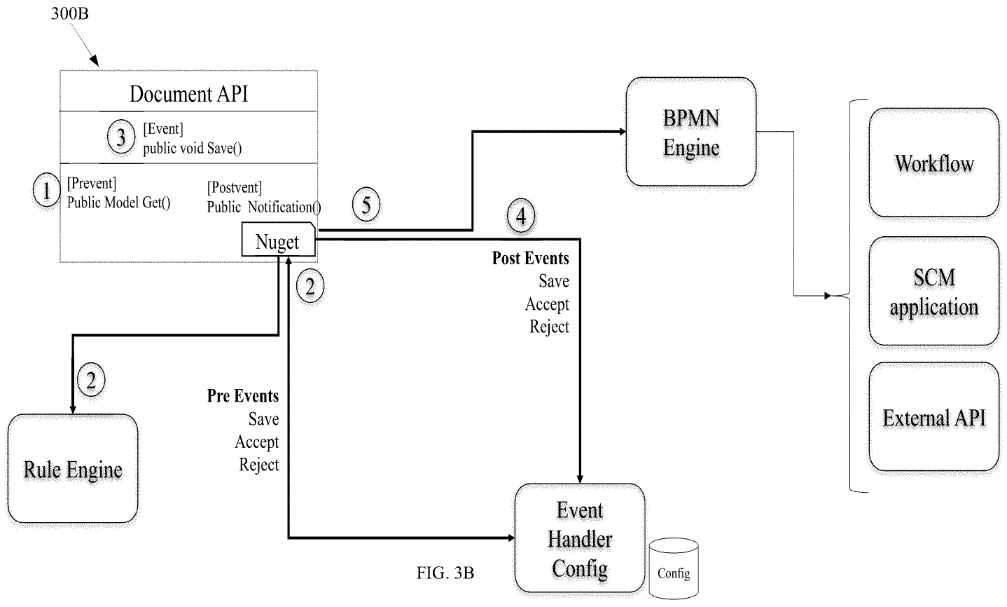

Referring to FIG. 3, a task and action service block diagram 300 as part of process orchestration is provided in accordance with an embodiment of the invention. The combination of State Machine, Action, Event handler and Access Control drive Supply chain application process. In Code less platform User Actions and Events are not coded explicitly. Events and Actions are mapped to standard API endpoints. Events are connected to Actions. Actions are associated to States. User interaction in SCM is different from that of traditional workflow systems. SCM applications are interactive and responsive. Web and Mobile applications follow the request-response model. User takes an action, by submitting the form. Forms fields are validated through client-side script and object model is sent to server side.

In an exemplary embodiment, various process and services can be attached to Events. Event has pre and post event handlers which can be configured through administration section as shown in flow diagram 300A of FIG. 3A. Some properties include Validation, Sequence, Priority, Sync or Async, Failure & Retry mechanism and Broker integration. The type of event includes data event with pre and post events as shown in flow diagram 300B of FIG. 3B. The event types also include service events and UI events. The pre-events for Data events are for Validation, synchronous events, using rule engine for validating. The Post-Event for Data events include Handling using same as Pre-events with Nuget, Async events and Triggering workflow. The Service Events are handles using service bus with Nuget to raise events while the UI events are handled from User task with Form. Events are eventually integrated with orchestration engine to perform the SCM operation.

In another exemplary embodiment the Process Orchestrator of the present invention has critical component integrated with User interface like Web or Mobile. The Orchestrator provides state and action services (manages Standard states; Actions & Events required to attain state or connected states), access Control Services (Stakeholders persona and activities; Actors relation to master data elements which will influence access control policies), and action Engine (Based on State/Action and Access Control policies, component provides related action on user interface. Action panels are integral component of UI footer section). The State and Action are customized by administrator and users. New State can be introduced as per business needs and related actions can be defined. UI panel of GEP codeless platform is designed to integrate with underlying engine without requiring additional code. Links will be displayed to the user based on access control, state of the document.

In an embodiment, the States correspond to stages in a SCM process. A state identifies a precise point within the process. In a given SCM process at a given state, the actions that can be taken by users are completely defined by the set of outgoing transitions. A state may have an entry action, an action that is executed upon entering the state, and an exit action, an action that is executed upon leaving the state.

In an embodiment, the actions correspond to task logic being executed at the application server. Actions can appear in states and transitions. An action can be used to interface to an external system, such as a workflow system handling its own set of functionalities. An action can be a conglomeration, or sequence, of pre-defined internal commerce actions. All actions caused by the processing of an event are run within the same transaction.

In an embodiment, the Event is a named message needing to get processed triggered from UI or from another process. E.g Approve/Reject is an Event attached to invoice.

In an embodiment, the rules are Set of conditions that need to be true before the action can be taken. Conditions are Boolean computations on the context of the business process and/or the parameters of the event. An access control condition is always present in the guard. Thus, the action on a transition is taken only if access is allowed. If no access control policy is explicitly specified, the default access control mechanism is used.

In an exemplary embodiment the platform architecture provides form designer feature. The platform provides base-level code, scripts, and integrations so users can prototype, build, or scale applications without developing complex infrastructures. Both developers and non-developers can use this tool for rapid application development with customized workflows and functionality.

Further, the platform as a product advantageously enables citizen developer user to create end to end application with additional customized microservices and API deployed and configured in CDS. The developer creates application templates based on the operational verticals with predefined rules and workflows and database schema for out of box implementation. Third party implementation entities can select the application, customize and extend schema based on specific needs of customer region and line of operation. The platform has an ability create microservices and schema dynamic based on standard templates and customize layer. It supports real-time reporting with Inbuild capability to integrate with data lake for real-time integration with reporting solutions. The platform supports multiple communication protocols including but not limited to SOA, REST and gRPC (g Remote procedure call). It also supports dynamic and centralized state model and event handler for multiple action types i.e standard event handler and customized event handler for pre-event, event and post event. The platform auto-corrects and reverse transactions in case of failures.

In a related embodiment, the platform enables end to end flow. It enables selection of application type, configuration of data attributes as required for operation execution. The platform dynamically generates code clocks and database schema based on filed property like type and mandatory etc. Code and queries are generator based on column and repository type, translated using GEP Query language standardized for multiple data stores. System generates multiple user action types. Event types are generated based on state model and sequence on actions. Unique ID is generated for type. Event Types are mapped by dynamic code modular responsible for distributed transaction. Every transaction is tracked using Process ID and Event ID. Every Event has predefined Event Handler. Event Handlers can be configured and extended from portal. Some of the event types include AUTOSAVE, READ, INSERT/UPDATE, DELETE, APPROVE/REJECT, and CUSTOM ACTION. Further, every Action type has mandatory Event Handler blocks including PRE-EVENT, POST-EVENT, EVENT, SECURITY HANDLER and EXCEPTION HANDLER. Based on time interval system by default initiated defined code block to save data in repository. Transaction is saved in default state defined in initial step. Read event generated through canvas low code portal has following flow. Event ID mapped to code block responsible to fetch transaction based on underlying data repository using READ Code block. Transaction flows through 4 layers invoked using gRPC and API based model. READ Event Handler invokes security pre-event handler to validate user access control using roles/activities and user relation with transaction based on metadata and inter relation with other attributes. Access control application service is invoked using remote procedure call (RPC) protocol such as gRPC protocol at shared framework layer through process orchestrator. In example embodiment, the layered architecture includes application layer and predefined event handler, shared Framework layer for translating event handler and model information into standard format, other layers for translating transaction model into generic query language and translating the generic query language into data repository language.

In an exemplary embodiment, the present invention provides a bouncer API for Data Access Security. The API provides Decorator attribute on Event Handlers to support security-based rules. The rules are executed against hierarchical model based on Users relation with master data and application transaction.

In an exemplary embodiment, the platform of the present invention provides creation of Seed project that includes common repository and template project containing all metadata information and applications can be built on top using these templates. This will enable faster development of applications and structuring of workflow by multiple application development teams. Additional Features required to implement as part of Seed project include project repository as seed for all entity/end user implementations, manage all the entities from single manage interface to decide which entity is going to view what specific data, setting the permission and access control to the application development team to help them maintain and deploy their features and fixes faster and safer for Version control.

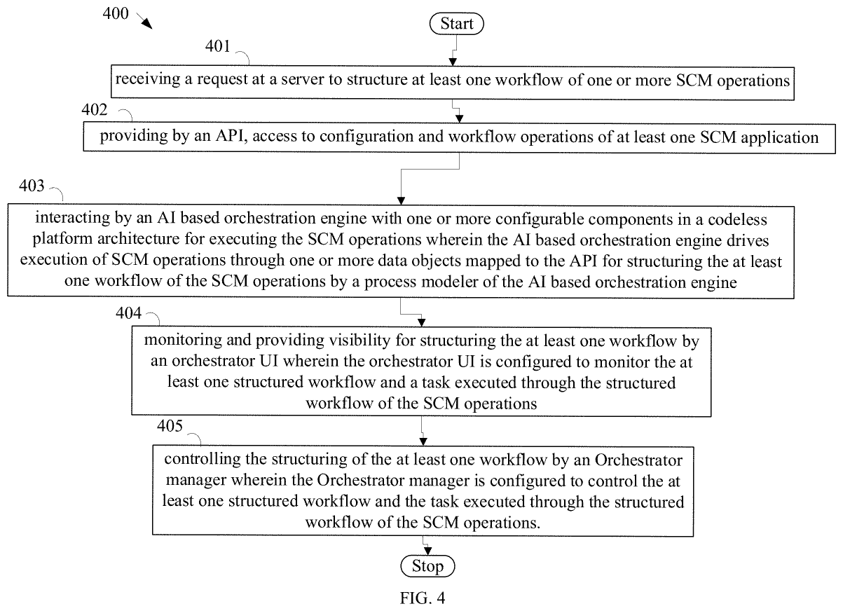

Referring to FIG. 4 a flowchart 400 depicting a method of process Orchestration in SCM enterprise application is shown in accordance with an embodiment of the invention. The method includes the steps of 401 receiving a request at a server to structure at least one workflow of one or more SCM operations. In step 402 providing by an API, access to configuration and workflow operations of one or more SCM application. In step 403 interacting by an AI based orchestration engine with one or more configurable components in a codeless platform architecture for executing the SCM operations wherein the AI based orchestration engine drives execution of SCM operations through one or more data objects mapped to the API for structuring the workflow of the SCM operations by a process modeler of the AI based orchestration engine. In step 404 monitoring and providing visibility for structuring the at least one workflow by an orchestrator UI wherein the orchestrator UI is configured to monitor the at least one structured workflow and a task executed through the structured workflow of the SCM operations; and in step 405 controlling the structuring of the at least one workflow by an Orchestrator manager wherein the Orchestrator manager is configured to control the at least one structured workflow and the task executed through the structured workflow of the SCM operations.

In an embodiment, the method of the invention includes remodeling the structure of workflow based on the task performed through workflow and corrected outliers.

In an embodiment, the method includes identifying the configurable components for structuring one or more SCM application UI, creating rules and creating processing logic for executing the at least one operation.

In an embodiment, the at least one operation includes creation of one or more SCM application operation including CLM, Inventory management, warehouse management, Cycle Counting, Material transfer, Pick List, warehouse management, Order Management, invoice management, Good Receipts, Credit Memo, service confirmation and timesheet, Goods Issue, Return Note, requisition, Demand and Supply planning, Vendor Performance and Risk Management, RFX, Auction, Project Management, Quality management, Forecast Management, cost modelling, purchase order and sales management, receivables, work order management, Supplier Order Collaboration, Control Tower, Budgeting, Item and Catalog Management.

In an exemplary embodiment, the method of the invention includes generating a plurality of fixtures created for performing the at least one operation by utilizing a library of functions stored on a functional database where a controller is encoded with instructions enabling the controller to function as a bot for generating the fixtures. The plurality of fixtures are backend scripts created by the bot based on the at least one operation, data objects and AI processing for enabling automation of the operation by the controller of the process orchestrator. The AI based processing includes a processing logic that integrates deep learning, predictive analysis, information extraction, planning, scheduling, optimization and robotics for processing the at least one operation by the process orchestrator.

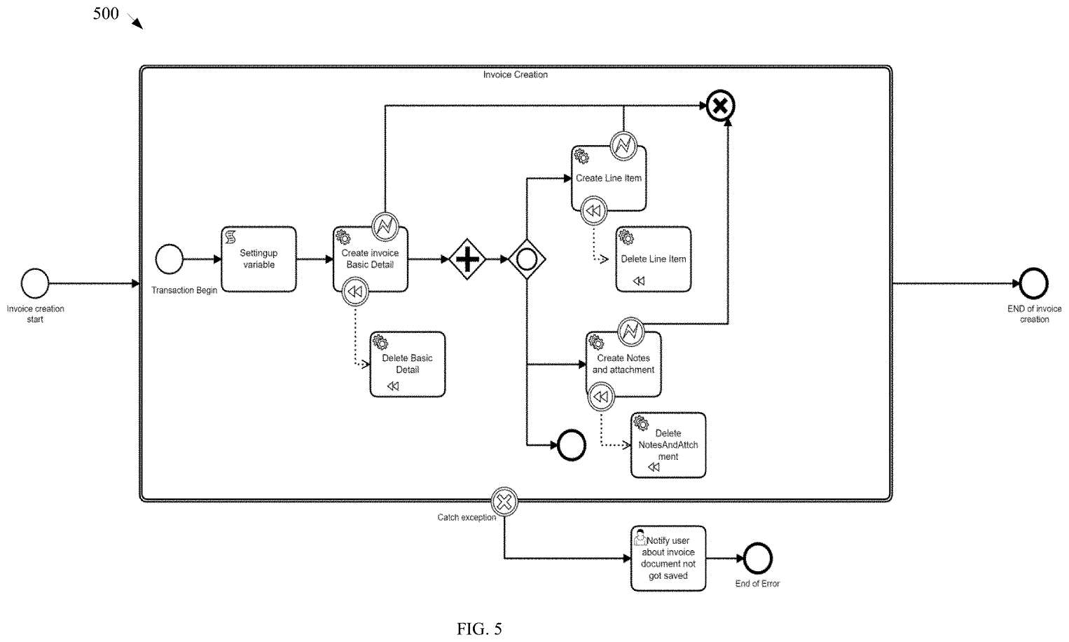

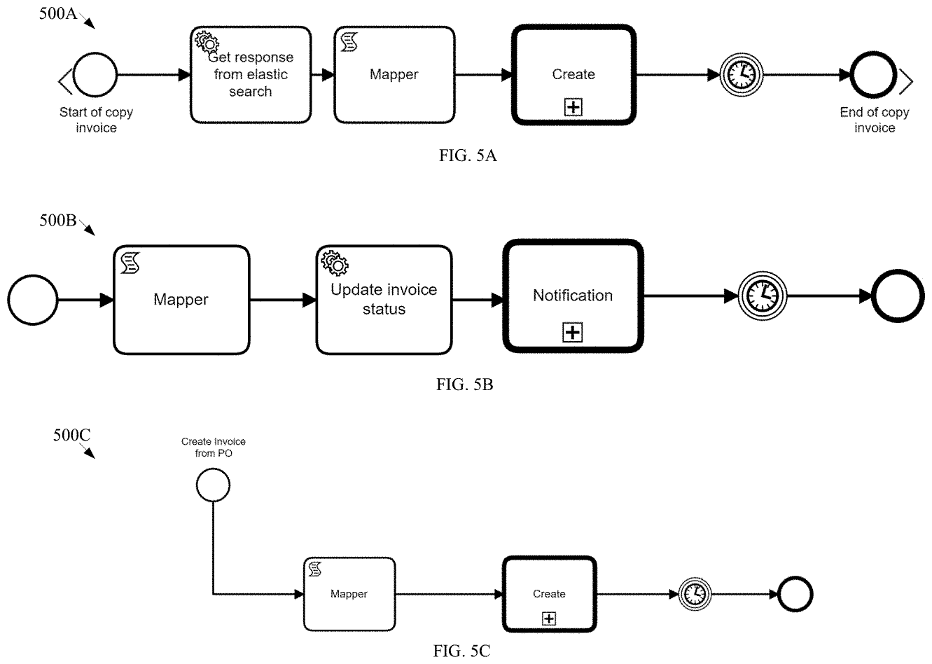

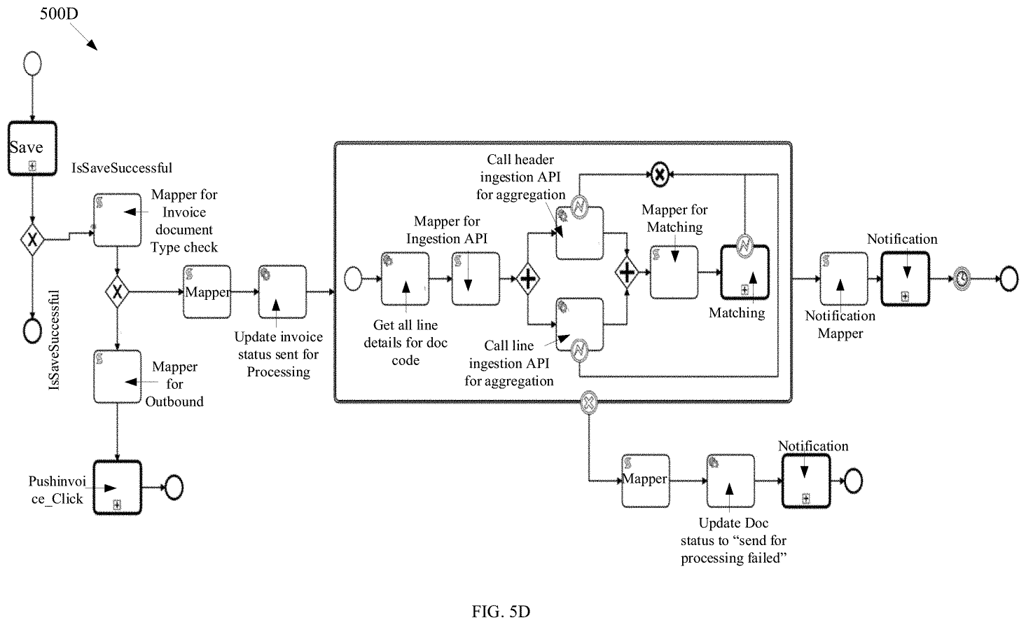

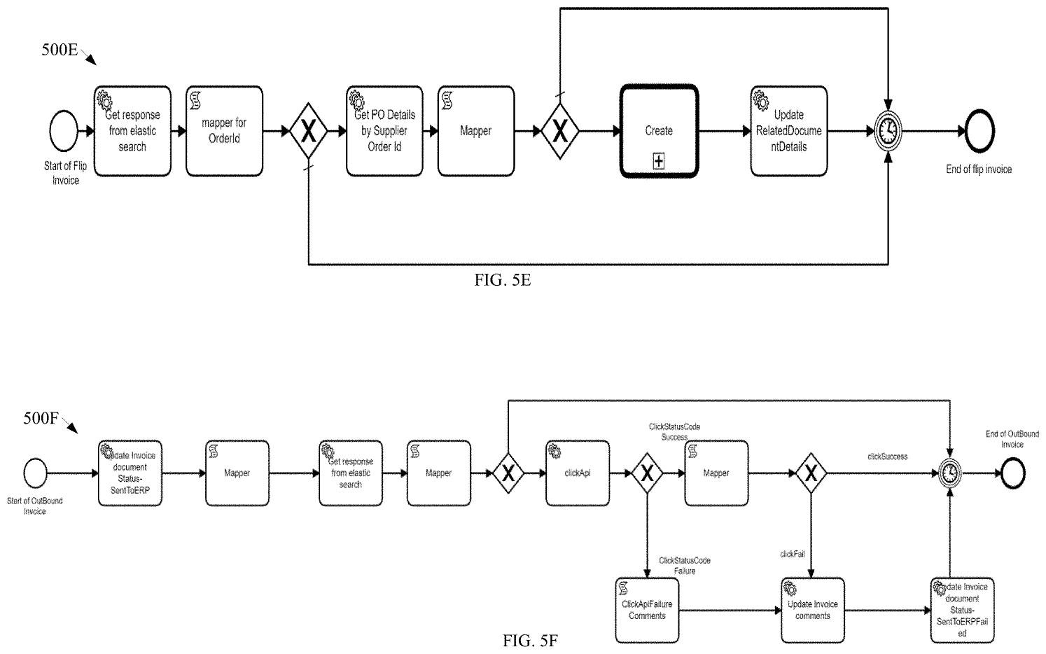

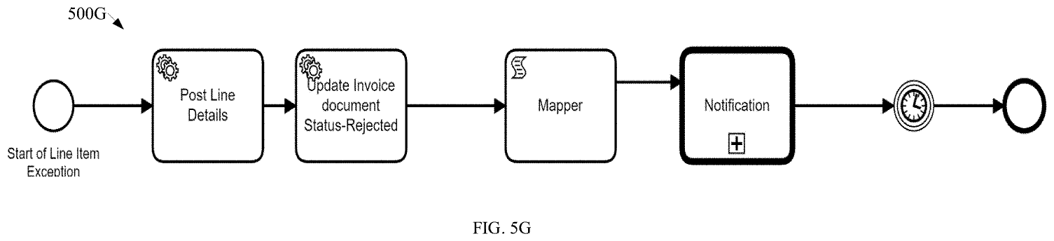

In an example embodiment, the invoice operations of Supply chain management application and process orchestration for structuring the related workflow is provided as shown in FIG. 5-FIG. 5G.

Referring to FIG. 5 is a flow diagram depicting creation of invoice workflow as a supply chain operation in accordance with an embodiment of the invention. The invoice creation includes beginning transaction, setting up variable, creating and deleting invoice basic detail, creating and deleting line item, creating and deleting notes and attachments, catching exception etc.

FIG. 5A is a flow diagram depicting copy invoice workflow as a supply chain operation in accordance with an embodiment of the invention.

FIG. 5B is a flow diagram depicting cancel invoice workflow as a supply chain operation in accordance with an embodiment of the invention.

FIG. 5C is a flow diagram depicting creation of invoice from Purchase Order workflow as a supply chain operation in accordance with an embodiment of the invention.

FIG. 5D is a flow diagram depicting submission of Invoice workflow as a supply chain operation in accordance with an embodiment of the invention.

FIG. 5E is a flow diagram depicting creation of sales invoice workflow as a supply chain operation in accordance with an embodiment of the invention.

FIG. 5F is a flow diagram depicting push invoice workflow as a supply chain operation in accordance with an embodiment of the invention.

FIG. 5G is a flow diagram depicting rejecting invoice workflow as a supply chain operation in accordance with an embodiment of the invention.

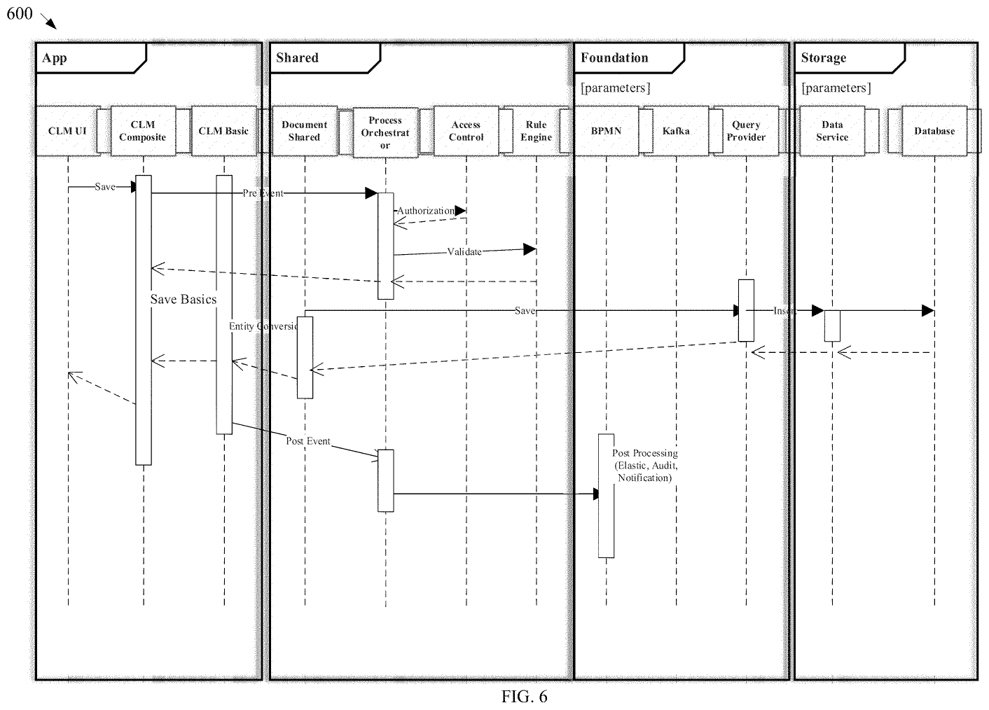

Referring to FIG. 6, a flow diagram 600 depicting codeless development of a create contract object flow operation of a contract lifecycle management SCM enterprise application with process orchestration is shown in accordance with an example embodiment of the invention. The flow diagram explains the flow as: a) User clicks on Save Document from CLM UI Plugin; b) CLM UI Plugin pass the CLM Object to CLM Composite; c) CLM Composite Invokes the Process Orchestrator through Pre-Event; d) Process Orchestrator checks the document access control, persona-based rights via Access Control Service; e) Process orchestrator validates the CLM objects via Business Rules configured Rule Engine; f) Once all the Pre-Checks are Done CLM Composite Invokes Save process by passing Bounded Context of each CLM Service like CLM Basic Service etc., g) CLM Basic Service Invokes Document Shared which internally transforms the view model in data Entity and invokes Platform Query Provider Service; h) Query Provider service construct the Query in GQL (Gep Query language) and invokes Data service for Saving Data in Data Storage; i) Success object is sent to UI Plugin for Save Confirmation; j) Post Event is invoked as Asynchronous Post Processing flow via process management Engine (like a business process management engine) for processing like Elastic Search Indexing, State Management, Notification etc.

In an embodiment, the platform architecture provides service fault tolerance. The platform supports Composite Service to implement Orchestrator Based SAGA pattern for distributed transactions. The platform includes centralized Controller (CLM Composite) Orchestrating the Transactions. The Controller Queues the requests in Messaging Queue with same correlation id. All the subscribers execute the messages in Queue. Once all the transactions are successful Contract Transaction commits save. The process orchestrator handles the failure through compensating transaction. All the services implement time Outs and retry (Polly Framework) policies.

In a related embodiment, the contract lifecycle management application as the supply chain management application supports asynchronous occurrence of all post save operations, consumption of platform services by gRPC connection, addition of redundant data in local cache to serve request faster, application of local cache policy at client side. Further, a write operation on Contract happens only in specific Stages till Contract is not live as read write operations can happen through Transactional Store. At a given time most of the Contracts are in Active state which Read-only state for such contracts data can be read through archived Store. Above retention Policy & CQRS (command query responsibility segregation) pattern reduces Transactional Load on system.

In an example embodiment, codeless development of a create purchase order operation of a SCM enterprise application is explained with the workflow as: a) User clicks on create purchase order action; b) “CreateOrderService” is invoked; c) “CreateOrderService” as a first step calls the “DataAccesscontrolservice” to confirm that the user has access to perform the creation order action; d) “CreateorderService”, then invokes “localizationservice”, to get the necessary localization attributes like language, date formats, address formats; e) On success calls, “GetOrgstructureService” which based on the domain configuration and user profile brings order specific header entities from CMDS; f) On success, “GetCustomerService” which provides the list of customers and related information to the “CreateOrderService” which are bound to the UI fields; g) On success calls, “GetMasterDataService” which provides the list of all the required master data like ship to, bill to addresses, state, zip, etc; h) On success calls, “LineItemsService” which in turn calls a multitude of services like DAC, master data, custom attribute, etc., and takes the responsibility of rendering the basic line section; i) The sequence of the above service interactions is controlled through “BusinessProcessOrchestrationService” (uses “ProcessOrchestratorService”); j) Basic order is now complete; k) depending on the “Document Type” selection, “CreateOrderService” passes the control to “ProcessOrchestrator” which based on the configuration invokes the “TemplateService” which in turn looks at the configured list of templates and picks the purchase order template configured for that domain; l) “CreateOrderService” gets the template and binds it in the UI using additional set of services; m) based on the configuration and the template subsequent services like “AccountingService” (will provide chart of accounts and make Ledger liability entry), Schedule lines/Promise lines Services (create schedules/promises); n) “CreateOrderService” will then invoke the validation service to run user defined UI validations; o) On success, the “CreateOrderService” will invoke the “SaveOrderService”, which will invoke the data layer for writing to the backend; p) Once the required order object is created, “CreateOrderService” will invoke “BusinessProcessOrchestrationService” to determine the next steps, since this is a sales order the next step is to route for reviews internally, Process orchestrator (PO) will invoke the “WorkflowService” which in turn will use the rule engine on the backend and the configured rules from the customization layer to determine who the order needs to be routed to; q) On success, PO will invoke workflow service for running approvals; r) On success, since this is a purchase order, process orchestrator will invoke the “Fulfillmentservice” and “ASNService”.

In an exemplary embodiment, the system may enable cognitive computing to improve interaction between a user and the enterprise application(s). The intelligent interface provides insight into dynamically changing parameters for execution of operation in SCM application.

In an advantageous aspect, the process orchestration system and method based on codeless platform architecture of the present invention enable Sourcing, Procurement and Supply Chain to create applications with industry seed projects having set of rules and workflow, process flow for various industries like Oil & Gas, FMCG, Finance etc.

The present invention uses Artificial intelligence, process orchestration and layered platform architecture where the entire operational logic in the service is transformed into engine reducing complex logic. The sequence flow is translated in the engine. It is very helpful to manage multitenant applications. Simulators also help to unit test the flow not only with in the bounded context but across applications with registered in the flow. The Platform architecture provides building highly scalable services. The platform includes both backend and frontend components (UI components, rules engine and workflow) being built from scratch. Platform offers productivity gain and accelerates implementation cycle.

In an exemplary embodiment, the present invention may be a process orchestration system, a method, and/or a computer program product. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A System for process Orchestration in one or more Supply chain management (SCM) application, the system comprising:
an application programming interface (API) for providing access to configuration and workflow operations of one or more SCM applications;
an AI based orchestration engine configured for interacting with one or more configurable components in a codeless platform architecture for executing one or more SCM operations wherein the AI based orchestration engine drives execution of the SCM operations through one or more data objects mapped to the API for structuring at least one workflow of the SCM operations by a process modeler of the AI based orchestration engine;
an orchestrator UI for monitoring and providing visibility for structuring the at least one workflow wherein the orchestrator UI monitors the at least one structured workflow and a task executed through the structured workflow of the SCM operations; and
an orchestrator manager configured to control the structuring of the at least one workflow wherein the orchestrator manager controls the at least one structured workflow and the task executed through the structured workflow of the SCM operations.

2. The System of claim 1, wherein the orchestrator UI provides details through graphical representation to customize data flow, workflow, manage run, settings, define functional fixtures, events, State Model and configuration to execute the workflow.

3. The System of claim 1, wherein the one or more data objects includes event data object, state data object, action data object and access control data objects, stakeholder types, rule expression data object, and master data objects.

4. The System of claim 1, wherein the one or more data objects are application functional data objects including Taxonomy associated to a document, sub class of the document, document Types, Application Types, Supplier location, Region of business, taxation attributes, Line attributes, clause type, approval type, and document value.

5. The System of claim 1, further comprising a historical workflow knowledge database configured for storing a historical workflow dataset wherein the workflow of the SCM operation is structured based on the historical workflow dataset by building model driven AI flows incorporating application process within supply chain.

6. The System of claim 3, wherein event data objects and action data objects are mapped to endpoints of the API.

7. The System of claim 6, wherein event data objects are connected to action data objects and action data objects are associated to state data objects.

8. The System of claim 2, wherein the AI based orchestration engine coupled to a processor executes the SCM operation by at least one data model wherein the AI engine transfers processed data to the UI for visibility, exposes SCM operations through the API and assist the manager for orchestration and control.

9. The System of claim 1, further comprising a blockchain connector configured for integrating blockchain services with the one or more SCM application.

10. The System of claim 1, wherein the AI based process orchestration engine includes an AI flow Orchestrator engine configured for monitoring and learning a data flow of SCM operations including input transactions data across different stages of SCM application.

11. The System of claim 1, wherein the AI based process orchestration engine includes an AI Task orchestrator engine configured for determining relative importance of different business rules to either automate tasks by a bot or determine dependencies to introduce execution optimizations.

12. The System of claim 1, wherein the AI based process orchestration engine includes an AI Compliance orchestrator engine configured to determine anomalies, process pattern drifts, approval optimization or community intelligence.

13. The System of claim 1, wherein the AI based process orchestration engine includes an AI resource orchestrator configured to focus on importance-driven QoS (Quality of Service) requirements to optimize resource allocation of the codeless platform.

14. The System of claim 10, wherein the AI flow Orchestrator engine is configured to define a data processing path based on a predicted task and perform clustering of transactions based on a plurality of data attributes and task metadata to determine an appropriate rule flow.

15. The System of claim 11, wherein the AI task orchestrator is configured to determine weightage of a task to be executed for identifying process to execute the task by a bot.

16. The System of claim 1, wherein the process modeler is configured to generate notations and define processes as per trained models stored in a data model repository wherein the modeler integrates one or more processes utilizing one or more tools.

17. A method of Process orchestration in supply chain management (SCM) application, the method comprising:
receiving a request at a server to structure at least one workflow of one or more SCM operations;
providing by an API, access to configuration and workflow operations of one or more SCM application;
interacting by an AI based orchestration engine with one or more configurable components in a codeless platform architecture for executing the SCM operations wherein the AI based orchestration engine drives execution of SCM operations through one or more data objects mapped to the API for structuring the at least one workflow of the SCM operations by a process modeler of the AI based orchestration engine;
monitoring and providing visibility for structuring the at least one workflow by an orchestrator UI wherein the orchestrator UI is configured to monitor the at least one structured workflow and a task executed through the structured workflow of the SCM operations; and
controlling the structuring of the at least one workflow by an Orchestrator manager wherein the Orchestrator manager is configured to control the at least one structured workflow and the task executed through the structured workflow of the SCM operations.

18. The method of claim 17, further comprising the step of:
remodeling a structure of the workflow based on a task performed through the workflow and corrected outliers.

19. The method of claim 17, wherein the orchestrator UI provides details through graphical representation to customize data flow, workflow, manage run, settings and configuration to execute the workflow.

20. The method of claim 17, further comprising building model driven AI flows incorporating application processes within a supply chain wherein the at least one workflow of the SCM operation is structured based on a historical workflow dataset.

21. The method of claim 17, further comprising generating notations and defining process by the processes modeler as per trained models stored in a data model repository wherein the modeler integrates one or more processes utilizing one or more data processing tools.

22. The method of claim 21, wherein the AI based orchestration engine coupled to a processor executes the SCM operation by at least one data model wherein the AI engine transfers processed data to the UI for visibility, exposes SCM operations through the API and assist the manager for orchestration and control.

23. The method of claim 17, further comprises integrating block chain services with the one or more SCM applications by a blockchain connector.

24. The method of claim 17, wherein the AI based process orchestration engine includes an AI flow Orchestrator engine configured for monitoring and learning a data flow of SCM operations including input transactions data across different stages of SCM application.

25. The method of claim 17, wherein the AI based process orchestration engine includes an AI Task orchestrator engine configured for determining relative importance of different rules to either automate tasks by a bot or determine dependencies to introduce execution optimizations.

26. The method of claim 17, wherein the AI based process orchestration engine includes an AI Compliance orchestrator engine configured to determine anomalies, process pattern drifts, approval optimization or community intelligence.

27. The method of claim 17, wherein the AI based process orchestration engine includes an AI resource orchestrator configured to focus on importance-driven QoS requirements to optimize resource allocation of the codeless platform.

28. The method of claim 24, wherein the AI flow Orchestrator engine is configured to define a data processing path based on a predicted action and perform clustering of SCM operations including transactions based on a plurality of data attributes and task metadata to determine an appropriate rule for workflow.

29. The method of claim 28, further comprising
extracting process identifier related to each SCM operation including transaction within a cluster;
extracting task sequences by traversing and
performing sequential pattern mining to determine common sequence of executed tasks on the cluster of transaction for recommending.

30. The method of claim 25, wherein the AI task orchestrator engine is configured to determine weightage of a task to be executed for identifying process to execute the task by a bot.

31. The method of claim 30, further comprising:
extracting a process identifier related to each SCM operation including transactions;
extracting a task identifier operating on the SCM operation;
generating a conditional probability matrix to predict importance of task to a task dependency and task to approval dependence.

32. The method of claim 26, wherein anomaly detection includes
extracting a process identifier related to a set of transactions;
extracting a set of task sequences by traversing, and
training a machine learning algorithm on false positives.

33. The method of claim 26, wherein process pattern drifts analyzes a workflow sequence over time, tracks sequence changes to the workflow over time and computes distance between workflow sequences to determine drifts and evolutions wherein the AI compliance orchestrator engine performs clustering of task sequences over time to determine any seasonality patterns.

34. The method of claim 26, wherein community intelligence is determined by analysing task sequences and processing suffix tree algorithm for large scale sequence alignment and comparison wherein for each task sequence a nearest sequence is recommended.

35. The method of claim 17, wherein the one or more SCM application operation includes CLM (Contract lifecycle management), Inventory management, warehouse management, Cycle Counting, Material transfer, Pick List, warehouse management, Order Management, invoice management, Good Receipts, Credit Memo, service confirmation and timesheet, Goods Issue, Return Note, requisition, Demand and Supply planning, Vendor Performance and Risk Management, RFX, Auction, Project Management, Quality management, Forecast Management, Supplier Order Collaboration, Control Tower, Budgeting, Quality Management System, Vendor Management, Field Ticketing, Item and Catalog Management.

36. The method of claim 35, further comprising generating a plurality of functional fixtures created for performing the one or more SCM operation by utilizing a library of functions stored on a functional database, wherein a controller is encoded with instructions enabling the controller to function as a bot for generating the fixtures.

37. The method of claim 36, wherein the plurality of functional fixtures are backend scripts created by the bot based on the at least one operation, data objects and AI processing for enabling automation of the operation by to be executed by the orchestration engine.

38. The method of claim 37, wherein the AI processing includes a processing logic that integrates deep learning, predictive analysis, information extraction, planning, scheduling, optimization and robotics for processing the at least one operation by the orchestration engine.

39. A computer program product for process orchestration in one or more SCM application of a computing device with memory, the product comprising:
a computer readable storage medium readable by a processor and storing instructions for execution by the processor for performing a method, the method comprising:
receiving a request at a server to structure at least one workflow of one or more SCM operations;
providing by an API, access to configuration and workflow operations of one or more SCM applications;
interacting by an AI based orchestration engine with one or more configurable components in a codeless platform architecture for executing the SCM operations wherein the AI based orchestration engine drives execution of SCM operations through one or more data objects mapped to the API for structuring the at least one workflow of the SCM operations by a process modeler of the AI based orchestration engine;
monitoring and providing visibility for structuring the at least one workflow by an orchestrator UI wherein the orchestrator UI is configured to monitor the at least one structured workflow and a task executed through the structured workflow of the SCM operations; and
controlling the structuring of the at least one workflow by an Orchestrator manager wherein the Orchestrator manager is configured to control the at least one structured workflow and the task executed through the structured workflow of the SCM operations.
